(19) United States
(12) Patent Application Publication
(10) Pub. No.: US 2016/0210683 A1
(43) Pub. Date: Jul. 21, 2016

(54) Order Offload

(71) Applicant: International Business Machines Corporation, Armonk, NY (US)

(72) Inventors: Faisal Aqlan, Poughkeepsie, NY (US); Warren Boldrin, Montgomery, NY (US); Kristal Diaz-Rojas, Highland, NY (US); Sreekanth Ramakrishnan, Salem, MA (US)

(73) Assignee: INTERNATIONAL BUSINESS MACHINES CORPORATION, Armonk, NY (US)

(21) Appl. No.: 14/599,860

(22) Filed: Jan. 19, 2015

(51) Int. Cl. G06Q 30/06

(52) U.S. Cl. CPC G06Q 30/0635

(57) ABSTRACT

Embodiments of the invention relate to inventory and resource sharing for sustaining a build-to-order supply chain. A multi-objective optimization model is formulated to identify an optimal strategy that is adaptive and responsive to customer demand to maintain and meet orders in the supply chain while mitigating demand and supply risks.

### BACKGROUND

The present invention relates to an optimization approach for order offload in an integrated enterprise. More specifically, the invention relates to mitigating supply and demand risks in a nested fabrication fulfillment environment by offloading orders and trans-shipping parts between different supply chain locations.

Inter-organizational trans-shipment and order offload are important decisions for organizations that have multi-site manufacturing. More specifically, the ability to offload provides the organization with an adaptive response to demand. At the same time, inter-organizational transportation cost is a factor, which in one embodiment may affect inventory and capacity. Decisions on where to optimally source an order when presented with multiple manufacturing sites include, but are not limited to, inventory supply position, site capacity, time zones, tax advantages or disadvantages, and distribution costs.

### SUMMARY

The invention includes a method, computer program product, and system for offloading product order in a distributed production system.

A method, computer program product, and system are provided for collaborative order fulfillment through inventory and resource sharing in a distributed production system. A host computer is employed to transform received product order data by inserting an option key into an optimization model. Output from the model includes formatted order fulfillment data representing a product manufacture objective. The formatted order data is returned from the host computer. More specifically, the formatted data identifies an optimal shipping option to meet the objective. The formatted data is applied to a product allocation workload, which also includes calibration of a product component manufacturing tool. This application minimizes cost of order fulfillment by offloading at least one component of the product order to a supply chain location that has the calibrated tool.

Other features and advantages of this invention will become apparent from the following detailed description of the presently preferred embodiment(s) of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a block diagram illustrating a multi-plant organization with order offload and inventory trans-shipment.

FIG. 2 depicts a flow chart illustrating a process for inter-organization capacity and inventory sharing, also referred to herein as order offload framework.

FIG. 3 depicts a flow chart illustrating a process for implementing a system for attaining a product order.

FIG. 4 depicts a flow chart illustrating a process for identifying shipping options associated with orders.

FIG. 5 depicts a flow chart illustrating a process for selection of a shipping option.

FIG. 6 depicts a block diagram illustrating a system for order offload.

FIG. 7 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Trends associated in globalization of sourcing, production, and sales, along with environmental and labor-based factors, have forced companies to have multiple manufacturing or service sites in different geographical locations. Such locations may be national or international, either of which supports multiple sites. Institutions with multiple locations assign their orders to the different sites to fulfill their objective(s). Order assignment can be based on several factors, including but not limited to shipping costs to customer(s), labor costs, raw material availability, capacity constraints, customer requirements, etc.

Supply and demand risks are assessed to ascertain if the multiple sites can be supported. In the event that the sites cannot be supported, orders can be reassigned and parts can be transported to other sites to avoid supply chain risks. There is an impact of demand forecasting where top level demand might be accurately forecasted, but the demand at the geographical level might have a degree of variance. Sites may be forced to re-balance purchased supply in order to meet overall demand.

Trans-shipment and order offload are important decisions for a multi-site manufacturing system. Such decisions provide the ability to be adaptive and responsive to product or service demand. Customer orders could be at risk due to the inventory shortage and/or capacity unavailability. Furthermore, in the case of limited inventory, allocation of parts to customer orders should be based on order priority.

Given inherent complexities associated with managing numerous operational variables in the order fulfillment process, it is essential to make accurate timely decisions. This is compounded by a discrete finite time constraint for revenue recognition. Decisions can be optimized, e.g. maximized or minimized, on any of these dimensions, however, it is imperative that the decision maker has a full view of the impact to the secondary and tertiary variables upon evaluation of how and where to source order load.

As described in detail herein, a methodology is provided for order offload in multi-site manufacturing and/or service environments. The method helps organizations enhance the confidence intervals around critical decisions to maximize revenue during the peak periods of load. Real-time optimization and models allow plant and order managers to quantitatively assess factors in supply chain capabilities to determine how to manage risk, lower costs, as well as provide increased stakeholder experience and customer satisfaction.

Customer orders are received by an order fulfillment center and are allocated to production sites based on cost and time factors. If a certain production site cannot fulfill the order on time due to capacity, time, inventory, or other constraints, the order may be offloaded to another site that can fulfill the order on time. One objective is to reduce or eliminate problems associated with order fulfillment in distributed production systems. More specifically, optimization techniques are employed to identify decisions for order fulfillment given a set of constraints related to capacity, production and transportation time, and material availability. Order data is pulled from databases, analyzed, and prepared to be used in the optimization model(s). Optimal shipping options associated with orders are identified based on order cycle time, transportation risk, and time difference between physical locations.

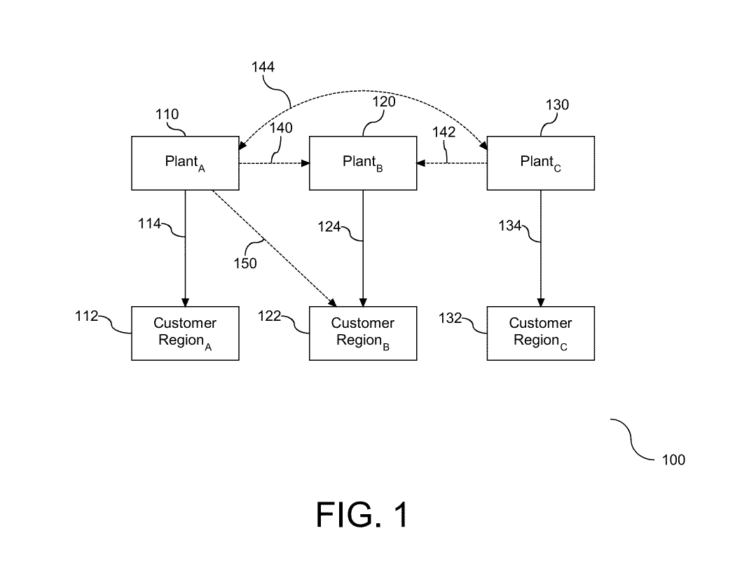

Referring to FIG. 1, a block diagram (100) is provided illustrating a multi-plant organization with order offload and inventory trans-shipment. Given a set of manufacturing sites in different geographical locations, customer orders are allocated to the different sites based on cost, time, policy, and other factors. Customer regions may be divided into groups, and each group may be assigned to a single manufacturing site. In one embodiment, one or more orders can be offloaded and the orders and/or associated parts can be transported from one site to another site in order to avoid supply and demand risks. As shown herein, there are three manufacturing plants, including plant_{A} (110), plant_{B} (120), and plant_{c} (130). Each plant has an associated customer region. More specifically, plant_{A} (110) has associated customer region_{A} (112), plant_{B} (120) has associated customer region_{B} (122), and plant_{c} (130) has associated customer region_{c} (132). Customers in their regions are supported by their regional plant. As shown, customers in region_{A} (112) are supported by plant_{A} (110) as shown as (114), customers in region_{B} (122) are supported by plant_{B} (120) as shown as (124), and customers in region_{c} (132) are supported by plant_{c} (130) as shown as (134). Accordingly, as shown, there is a direct correspondence between select plants and associated customer regions.

Each customer order is composed of order quantity, order type, order configuration, order destination, and order ship date. A manufacturing site may not be able to meet each of the parameters to fulfill a customer order for a variety of factors, including, but not limited to, raw material shortage, capacity constraints, time limitations, and customer requirements. For raw material shortage, the site can obtain such material from a related site of an external supplier. For the factors pertaining to capacity, time, and customer requirements, the site can offload the orders to a related site that can fulfill the order. As shown herein, an order offload may occur between plant_{A} and plant_{B} (140), plant_{B} and plant_{c} (142), and plant_{A} and plant_{c} (144). Similarly, as shown herein, an order for a customer region may be supported by an alternate plant, as shown at (150). Accordingly, the inter-relationship between customer regions and plants shown herein provides flexibility with respect to product trans-shipment.

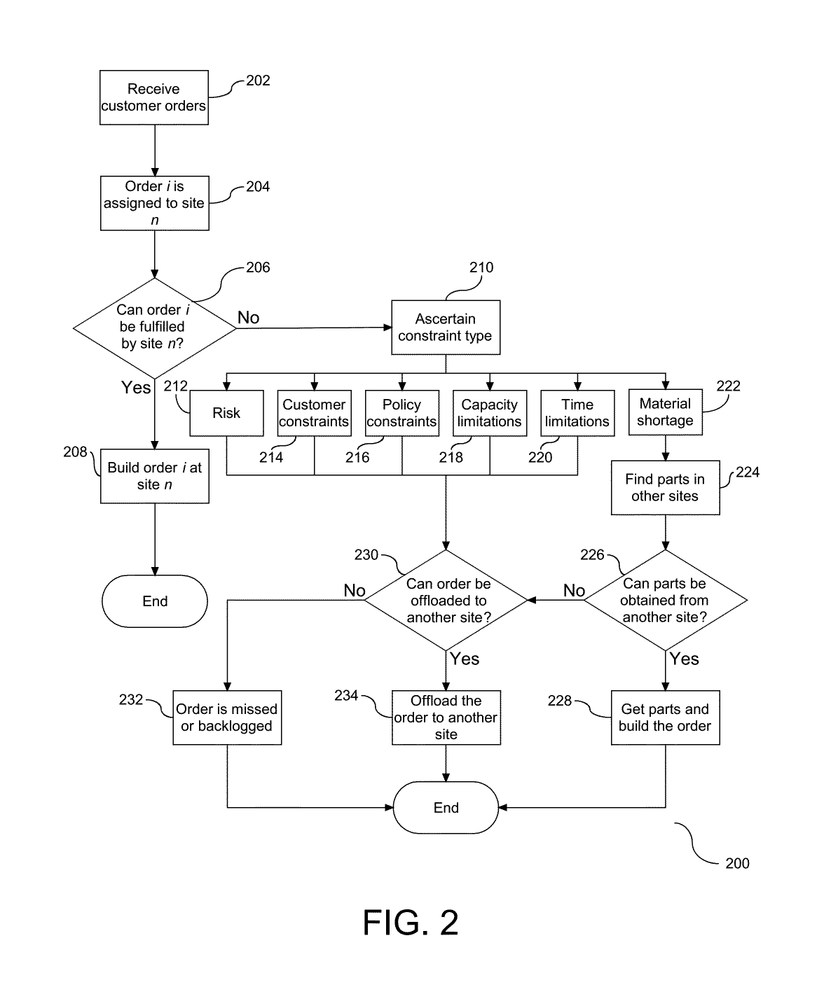

Referring to FIG. 2, a flow chart (200) is provided illustrating a process for inter-organization capacity and inventory sharing, also referred to herein as order offload framework. Customer orders are received by a central order management department (202) and assigned to different sites. More specifically, order i is assigned to site n (204), with the assignment based on customer region and company policy. It is then determined if order i can be fulfilled by site n (206). If a certain manufacturing site can fulfill the order assigned to it, the order is built at that site (208), as demonstrated by a positive response to the determination at step (206). However, if the manufacturing site cannot fulfill the order, as demonstrated by a negative response to the determination at step (206), the constraint type that is the basis for the inability to fulfill the order is ascertained (210). Six constraint types are exemplified, including risk (212), customer constraints (214), policy constraints (216), capacity limitations (218), time limitations (220) and material shortage (222). Capacity (218) is represented by the number of products that can be produced at a given time period. Time (220) is the total time for fulfilling the order and must be less than or equal to the ship date of the order. Policy (216) and customer constraints (214) force the order to be produced at a selected plant. Risk (212) is avoided through shipping parts and/or with shipping options have the lowest risk level.

If the order cannot be fulfilled because parts cannot be obtained on time or because of capacity, time, or other constraints, the order can be offloaded to another site that can potentially fulfill the order on time. For material shortage (222), only parts available in other sites owned by or affiliated with the company are considered (224). As such, it is determined if the parts can be obtained from another site (226). A positive response is followed by getting the parts and building the order (228). However, if the parts cannot be obtained, as demonstrated by a negative response to the determination at step (226) or following one of steps (212)-(220), it is determined if the order can be offloaded to another site (230). A negative response to the determination at step (230) indicates that the order is missed or backlogged (232), and a positive response is followed by offloading the order to another site (234).

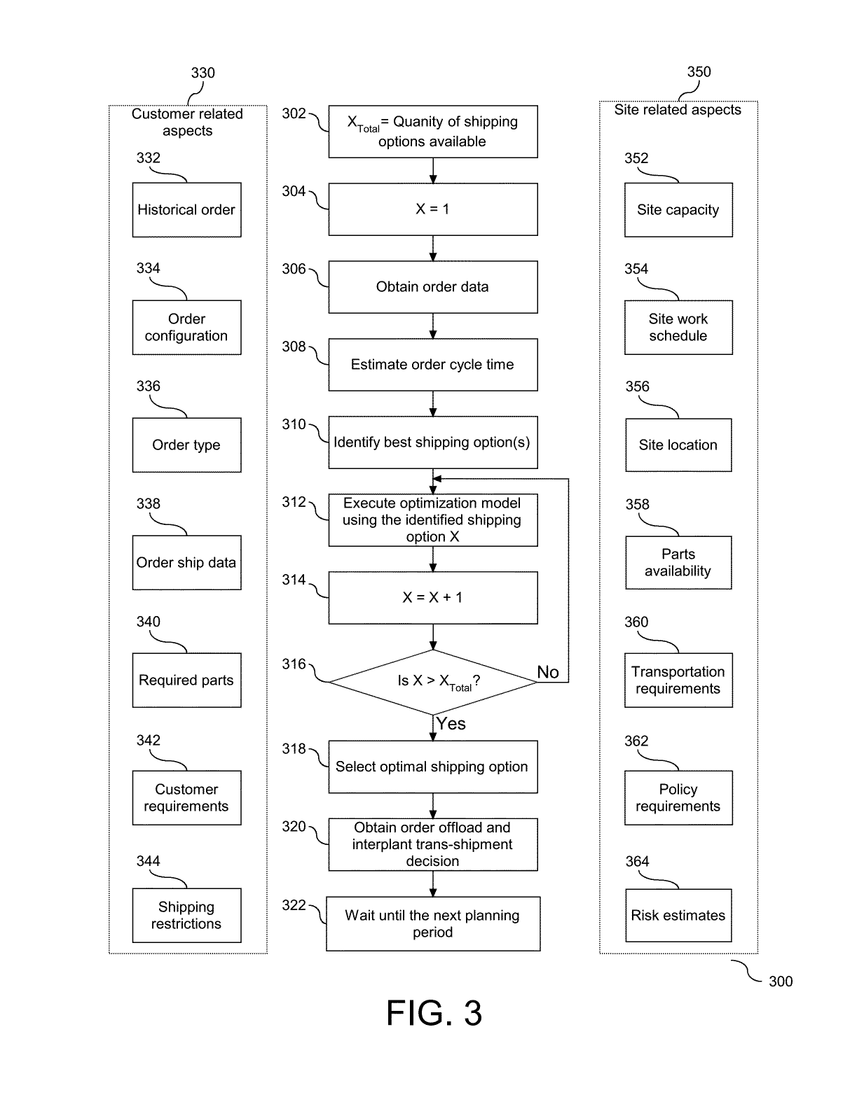

Referring to FIG. 3, a flow chart (300) is provided illustrating a process for implementing a system for attaining a product order. Two input categories to the process are shown. More specifically, the input categories include, but are not limited to, customer related aspects (330) and site related aspects (350). Examples of the customer related aspects (330) include, but are not limited to, historical orders (332), order configuration (334), order type (336), order ship data (338), required parts (340), customer requirements (342), and shipping restrictions (344). Examples of site related aspects (350) include, but are not limited to, site capacity (352), site work schedule (354), site location (356), parts availability (358), transportation requirements (360), policy requirements (362), and risk estimates (364). Accordingly, input of both customer and site aspects factor into the system implementation.

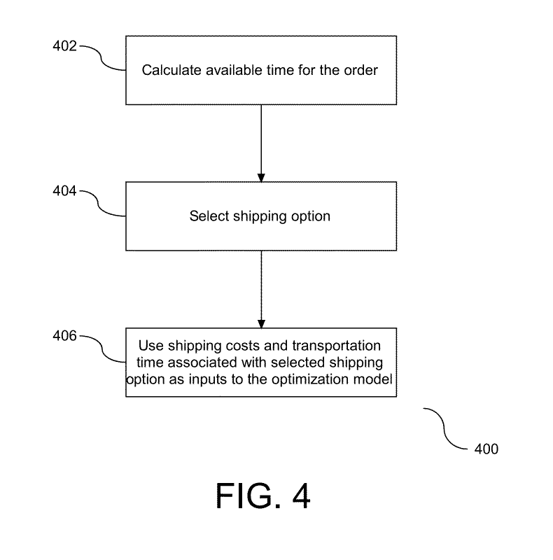

As shown, the variable X_{Total} is assigned to the quantity of shipping options available (302) and an associated counting variable X is initialized (304). Following the initialization steps, the order data is obtained (306), which in one embodiment is stored in a database. Based on historical data, order cycle time is estimated (308). The estimate at step (308) is based on historical order data, order configuration, and order type. Following the estimate at step (308), the best shipping option(s) associated with the orders is identified (310). Details of the estimate are shown and described in FIG. 4, and supported in Tables 2 and 3. Input for the estimate is based on the order ship date and any shipping restrictions. An optimization model is executed using the identified shipping option X (312). Input for the optimization model includes the order type, order ship date, required parts, and customer requirements. Details of the optimization model are described in detail below.

Following execution of the optimization model for shipping optionₓ, the associated counting variable X is incremented (314). It is then determined if all of the identified and available shipping options have been considered (316). A negative response to the determination is followed by a return to step (312). However, a positive response to the determination is followed by selecting the optimal shipping option available to obtain the objective, which in one embodiment is based on minimal time and cost (318). Following the selection at step (318), the order offload and interplant trans-shipment decision is obtained (320) until the next planning period (322). Accordingly, for each planning period the implementation executes an optimization model to obtain an objective that mitigates time and cost.

As referenced in FIG. 3, an optimization model is executed with respect to available shipping options. The choice between offloading an order to another manufacturing site and importing parts for assembly from another site requires a multiple factor evaluation. Such factors include, but are not limited to, cost of transportation, available time, and customer requirements. The optimization model is formulated to facilitate decision making, and in one embodiment, decisions associated with product manufacture. The model is based on the following four assumptions:
1. Production capacity limit is defined in terms of the maximum number of products that can be processed at any period of time;
2. Tax rates for shipping finished products from any manufacturing site to the customer are ignored;
3. Parts transported for an order from one site to another site are shipped as one batch;

and
4. Only one shipping option is considered for delivering orders to customers.

The optimization model is a multi-variable assessment. The following table, Table 1, is a notation table for an order offload optimization model.

TABLE 1

| Symbol | Description |
|---|---|
| J | set of production plants (indexes: j and j′) |
| K | set of customer regions (index k) |
| L | set of finished products (index l) |
| M | set of products types (index m) |
| N | set of parts (index n) |
| capⱼₗ | capacity of plant j for product l |
| CAPⱼ | total capacity of plant j |
| PCⱼₗ | unit processing cost of product l at plant j |
| TCⱼₖₘ | unit transportation cost of product l of type m from plant |
| | j to customer region k |
| TCⱼₗ^{j′} | unit transportation cost for order l parts from plant j′ to |
| | plant j, j′ ≠ j |
| PSSDₗ | shipping date for product l |
| LTⱼₗ^{j′} | average lead time to transport order l parts part from |
| | plant j′ to plant j |
| LTⱼₖₘ | average lead time to transport product l of type m from |
| | plant j or j′ to customer k |
| PTⱼₗ | average processing time for product l at plant j |
| yₗₙ | number of units of part n used in product l |
| Yⱼₙ | quantity of part n currently available at plant j |
| wₙ | weight of part n |
| SPⱼₗ^{j′} | shipping option associated with order l parts from plant j |
| | to plant j′ |
| TDⱼ^{j′} | time difference between plant (site) j and plant (site) j′ |
| WSⱼ | work schedule for plant j |
| WS_{j′} | work schedule for plant j′ |
| TSⱼ^{j′} | transportation schedule of parts between plants j and j′ |
| Tₗₘ | a parameter that represents the relationship matrix for |
| | finished products (L) and product types (M) |

The function of the optimization model is to minimize total cost and total time for building one or more orders. In the basic optimization model, two decision variables are employed with respect to product and parts as follows:

$${X}_{ij} = \{ \begin{matrix}1 , & if product i is to be built at plant j \\ 0 , & otherwise\end{matrix} \}$$

yⱼₗₙ^{j′}: number of parts of type n for order l to be transported from plant j to plant j′; j∉J/{j′}

Using the decision variables, the following model formulation is employed, with a multi-objective non-linear mixed integer programming model, including a first objective function to minimize total cost:

$$Min {\sum }_{j = 1}^{J} {\sum }_{l = 1}^{L} {PC}_{jl} {X}_{jl} + {\sum }_{j = 1}^{J} {\sum }_{k = 1}^{K} {\sum }_{l = 1}^{L} {\sum }_{m = 1}^{M} {TC}_{jkm} {T}_{lm} {X}_{jl} + {\sum }_{{j}^{′} = 1}^{J} {\sum }_{j = 1}^{J / \{ {j}^{′} \}} {\sum }_{n = 1}^{N} {\sum }_{l = 1}^{L} {TC}_{jl}^{{j}^{′}} {w}_{n} {y}_{jln}^{{j}^{′}} \qquad ( 1 )$$

and a second objective function to minimize total time:

$$Min {\sum }_{j = 1}^{J} {\sum }_{l = 1}^{L} {PT}_{jl} {X}_{jl} + {\sum }_{j = 1}^{J} {\sum }_{k = 1}^{K} {\sum }_{l = 1}^{L} {\sum }_{m = 1}^{M} {LT}_{jkm} {T}_{lm} {X}_{jl} + {\sum }_{{j}^{′} = 1}^{J} {\sum }_{j = 1}^{J / \{ {j}^{′} \}} {\sum }_{n = 1}^{N} {\sum }_{l = 1}^{L} {LT}_{jl}^{{j}^{′}} min ( l , {y}_{jnl}^{{j}^{′}} ) \qquad ( 2 )$$

where Tₗₘ is a given parameter having a value of zero or one. More specifically, this given parameter makes sure the order is only one product type. In one embodiment, a value of zero for this given parameter indicates that the product is not the type being considered, and a value of one indicates that the product is the type being considered.

The first objective function (1) minimizes the total cost of order fulfillment, which includes production cost and transportation cost of products and parts. The second objective function minimizes the total time of order fulfillment, which includes production time and transportation time of products and parts. The first and second objective functions are subject to a plurality of constraints. The first constraint is defined as follows:

$${\sum }_{j = 1}^{J} {X}_{jl} \leq 1 ; ∀ l ∈ L \qquad ( 1 )$$

, which ensures that a product is built only in one plant. More specifically, this objective function minimizes total cost of order fulfillment, which includes production cost and transportation cost of products and parts. The second and third constraints are defined as follows:

$$\begin{matrix}{\sum }_{l = 1}^{L} {X}_{jl} \leq {CAP}_{j} ; ∀ l ∈ J & ( 2 ) \\ {\sum }_{l = 1}^{L} {X}_{jl} {T}_{lm} \leq {cap}_{jm} ; ∀ l ∈ J , m ∈ M & ( 3 )\end{matrix}$$

The second and third constraints are referred to herein as capacity constraints. More specifically, the second constraint represents that the number of orders produced cannot exceed capacity of an associated manufacturing site, and the third constraint represents that the number of orders cannot exceed capacity for a given type. The fourth and fifth constraints are referred to herein as policy and customer constraints, respectively.

$$\begin{matrix}{\sum }_{j = 1}^{j} {X}_{jl} {Pol}_{jl} = 1 ; ∀ l ∈ L & ( 4 ) \\ {\sum }_{j = 1}^{J} {X}_{jl} {Cust}_{jl} = 1 ; ∀ l ∈ L & ( 5 )\end{matrix}$$

More specifically, the fourth constraint forces the location of production based on a policy constraint. For example, a site may be tooled to produce a limited number of products. As such, the fourth constraint ensures that a specific order, or a specific quantity of orders, may only be produced at a site configured for the production. The fifth constraint forces the location of production because of customer demands.

In addition to the policy and customer constraints described above, there are several inventory constraints. The sixth constraint,

$${\sum }_{j = 1}^{J} {\sum }_{l = 1}^{L} {X}_{jl} {y}_{ln} \leq {\sum }_{j = 1}^{J} {Y}_{jn} ; ∀ n ∈ N \qquad ( 6 )$$

ensures that there are a sufficient number of parts available for all orders. More specifically, this constraint specifies that the parts in any given site should be available for all received orders. The seventh constraint,

$${\sum }_{{j}^{′} = 1}^{J / \{ {j}^{′} \}} {\sum }_{l = 1}^{L} {y}_{jln}^{{j}^{′}} \leq max ( 0 , {Y}_{jn} - {\sum }_{l = 1}^{L} {X}_{jl} {y}_{ln} ) ∀ j ∈ J , n ∈ N \qquad ( 7 )$$

pertains to transport of parts. More specifically, this constraint ensures that the number of parts transported from a site is less than or equal to the extra number of parts available at an associated source site.

$${\sum }_{l = 1}^{L} {X}_{jl} {y}_{ln} \leq {Y}_{jn} + {\sum }_{{j}^{′} = 1}^{J / \{ j \}} {\sum }_{l = 1}^{L} {y}_{{j}^{′} ln}^{{j}^{′}} ; ∀ j ∈ J , n ∈ N \qquad ( 8 )$$

Accordingly, the inventory constraints support product order and transportation of parts to ensure that products ordered and assigned for manufacture are supported by the sum of the parts that comprise the product.

Product order and assembly have an associated schedule. More specifically, scheduling includes transportation schedule for delivery of parts that are assembled into the product, order completion time, shipment or scheduling shipment of the final assembly product, etc. The following constraint,

$$( {PT}_{jl} + {\sum }_{m = 1}^{M} {LT}_{jkm} {T}_{lm} ) {X}_{jl} {\sum }_{{j}^{′} = 1}^{J / \{ j \}} {\sum }_{n = 1}^{N} {LT}_{{j}^{′} l}^{j} min ( 1 , {y}_{jln}^{{j}^{′}} ) \leq {PSSD}_{l} ; \\ ∀ j ∈ J , k ∈ K , l ∈ L \qquad ( 9 )$$

defines the mathematical aspect to address shipping date constraints. More specifically, this constraint ensures that the total time for fulfilling the order is less than or equal to the shipping data of the order.

The final sets of constraints related to input into the objective functions. More specifically, the following three constraints:

SPⱼₗ^{j′}=ƒ(PTⱼₗ,PSSRₗ,TDⱼ^{j′},WSⱼ,WS_{j′},TSⱼ^{j′}); (10)

TCⱼₗ^{j′}=ƒ(SPⱼₗ^{j′}); (11) and

LTⱼₗ^{j′}=ƒ(Sⱼₗ^{j′}) (12)

are related to the shipping options associated with product orders. Finally, the following constraint,

yⱼₗₙ^{j′}=0; ∀j=j′, n∈N, l∈L (13)

pertains to inter-plant shipment. More specifically, this constraint ensure that the parts for the product assembly are only transported on an inter-plant basis and not an intra-plant basis. There are two decision variables that define the inter-plant shipment basis, including:

Xⱼₗ∈[0, 1], binary

Where the variable X represents product. More specifically X_{j,l} is a binary variable having the value of 1 or 0, with 1 representing if product i is to be built at plant j, and 0 represents otherwise. The decision variable Y represents parts subject to transportation for assembly. The following variable,

yⱼₗₙ^{j′}

represents the number of parts of type n for product l to be transported from plant j to plant j′, e.g. inter-plant shipment of parts.

Based upon the optimization formulation, decision variables, and constraints, the available time to ship parts for the order is calculated. Referring to FIG. 4, a flow chart (400) is provided illustrating a process for identifying shipping options associated with orders. As shown, the available time for the order is calculated (402). In one embodiment, the following formula is provided to assess the available time for the order:

Available time=[(PSSD−Today's Date)\Weekends))±Time Difference]−[Productiontime]

The variable PSSD represents the plant scheduled shipping date, weekends represents the fact that parts and orders are not shipped on weekends, and the TimeDifference represents the time different between different sites that send or receive parts for the product assembly. Following the calculation at step (402), the shipping option is selected (404). The following tables represent available shipping option selections between two different sites, including:

TABLE 2
New York to France

Express Shipping (SLX): 3.3 > SLX: 3.5 > Available time >=2
SLI: 4.5 > AvialableTime >= 3.5/Sundays
SL2: 5 > Available Time >= 4.5/Weekends
SL3: Available Time >= 5/Weekends

and

TABLE 3
New York to Singapore

Express Shipping (SLX): 3.3 > Available time >=3/weekends
SLI: 4.5 > AvialableTime >= 3.3/Weekends
SL2: 6.33 > Available Time >= 4.5/Weekends
SL3: Available Time >= 6.3/Weekends

where, SLX represents express shipping options in terms of time for completion of the shipment, and SL1, SL2, and SL3 represent alternative non-express shipping options, also in terms of time for completion of the shipment. In one embodiment, the shipment options are all provided by a shipping company, and the selection of the option(s) is based on time and shipping costs. The following table is an example of cost associated with shipping parts from New York to Singapore or New York to France for each of the above-listed shipping options:

TABLE 4

| Shipping Option | Cost (USD) |
|---|---|
| SLX | $850 (for truck) + $1.41 per pound |
| SL1 | $1.00 per pound |
| SL2 | $0.64 per pound |
| SL3 | $0.59 per pound |

Following the selection at step (404), the shipping costs and the transportation time associated with the selected shipping option are used as inputs to the optimization model (406). Accordingly, the shipping options are provided, with the selection based upon time and cost.

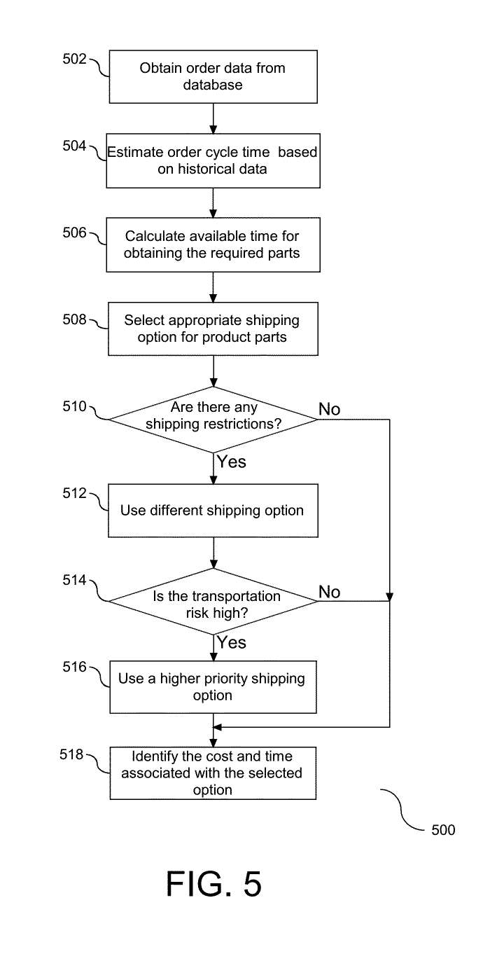

Referring to FIG. 5, a flow chart (500) is provided illustrating a process for selection of a shipping option. As shown, order data is obtained from a database (502), and the order cycle time is estimated based on historical data (504). Input for the estimate at step (504) includes historical order data, order configuration, and order type. Following the estimate at step (504), the available time for obtaining the ordered parts is calculated (506). In one embodiment, the Formula 1 referenced in FIG. 4 is employed in the estimated at step (506). The calculation employs the following factors as input: order ship date, transportation requirements, plant location and plant work schedule. Thereafter, an appropriate shipping option for product parts is selected (508). In one embodiment, the shipping options selection shown in Tables 2, 3, and 4 are consulted to support the selection. Similarly, in one embodiment, the required parts for the product assembly are received as input to the selection at step (508).

It is then determined if there are any shipping restrictions (510). In one embodiment, there may be restrictions on material and/or shape of parts under different shipping options. A positive response to the determination at step (510) is followed by using a different shipping option (512). Examples of input for the option change at step (512) include, but are not limited to, required parts and shipping restrictions. Following step (512), risk consideration evaluation is conducted. More specifically, it is determined if the transportation risk associated with the selected shipping option is high (514). Examples of the transportation risk include, but are not limited to, transport through a volatile geographic area, risk of transportation delay, etc. A positive response to the determination at step (514) is followed by using a higher priority shipping option (516). Input for the selection at step (516) include, but is not limited to, risk estimates and plant location. Following a negative response to the determinations at steps (510) or (514), or following the input selection at step (516), the cost and time associated with the selected option is identified (518), as shown as described in step (310) of FIG. 3. Accordingly, shipping options may be modified based on time and cost.

Risk management in high end manufacturing is important since such manufacturing is primarily based on outsourcing parts from different suppliers in different locations. Demand and supply risks are critical risks and should be managed effectively since missing a customer order means losing sales. In the description provided herein, order offload and interplant trans-shipment is shown with three manufacturing sites, each site in a different country and associated time zone. Each manufacturing site serves customers in its respective geographical area. For example, in the United States site serves North and South America, the European site serves Europe, Middle East, and Africa, and the Fast East site serves Asian countries and Australia. In one embodiment, main hardware components are sourced from suppliers across the globe, including Mexico, China, Taiwan, and Japan. To add to the complexity, the manufacturing environment is based on build-to-plan and make-to-order production and strategies.

The manufacturing described herein may apply to various multi-component products, including high tech and low tech products. High end server manufacturing is characterized by aggressive introduction cycles of new products, extreme demand skews, significant engineering changes, and high inventory carrying costs. The servers include components that incur high inventory carrying costs. Servers and their components require extensive tests to ensure high reliability and quality requirements. Multi-tier suppliers with long lead time provide the line with the required supplies. The manufacturing environment is based on a configure-to-order process, which is a combination of build-to-plan and make-to-order processes. This configuration is also known as fabrication fulfillment strategy, which allows for effective response to customer orders and lower inventory carrying costs. In the fabrication stage, components, also referred to herein as subassemblies, are produced, tested, and assembled based on a forecasted plan. Components are then kept in inventory until an order is received from a customer. In the fulfillment stage, tested commodities are assembled according to actual customer orders and finished goods inventory is not maintained. Inventory management is a challenging task. Main hardware components of the server include, but are not limited to, memories, modules, boards, frames, power, and logic cards. Parts are received from four types of suppliers, external suppliers, external onsite suppliers, internal onsite suppliers, and internal offsite suppliers.

The following is an example of execution of the optimization model based on the following input data: 3 manufacturing sites, 4 product types, 6 parts, 4 customer regions, and 100 orders allocated to the three sites. Given three manufacturing sites owned by an entity, orders are assigned to the site based on cost, time, and policy factors. Parts needed for the orders are distributed among the three sites. The allocation of orders is as follows: 45 orders are allocated to plant₁, 30 orders are allocated to plant₂, and 25 orders are allocated to plant₃. The following is a table illustrating interplant trans-shipment of parts for plant₁:

| Part Type | Plant (TO) | Plant (From) | Number of Parts Transported |
|---|---|---|---|
| 1 | 1 | 1 | 0 |
| 1 | 1 | 2 | 0 |
| 1 | 1 | 3 | 0 |
| 1 | 2 | 1 | 9 |
| 1 | 2 | 2 | 0 |
| 1 | 2 | 3 | 7 |
| 1 | 3 | 1 | 0 |
| 1 | 3 | 2 | 0 |
| 1 | 3 | 3 | 0 |

The number of parts transported is based on a site missing a part for product assembly. For example, interplant shipment of part₁ from plant₂ to plant₃ is because plant₂ is missing part₁

As shown and described herein, the risk of missing a customer order in a nested supply chain having multiple production sites sharing their capacity and/or inventor is minimized. More specifically, the processes shown herein consider and identify available raw material in the nested supply chain and employ an algorithm to check whether this raw material can be shipped to another site. Order offload is considered in case the raw material cannot be shipped on time given that the other site is willing to build the offloaded order. The total order fulfillment cost and time, along with the risk of missing an order, are minimized. Inter-organizational trans-shipment and order offload are important decisions for companies that have multi-site manufacturing systems. These decisions provide a company with the ability to be adaptive and responsive to customer demand.

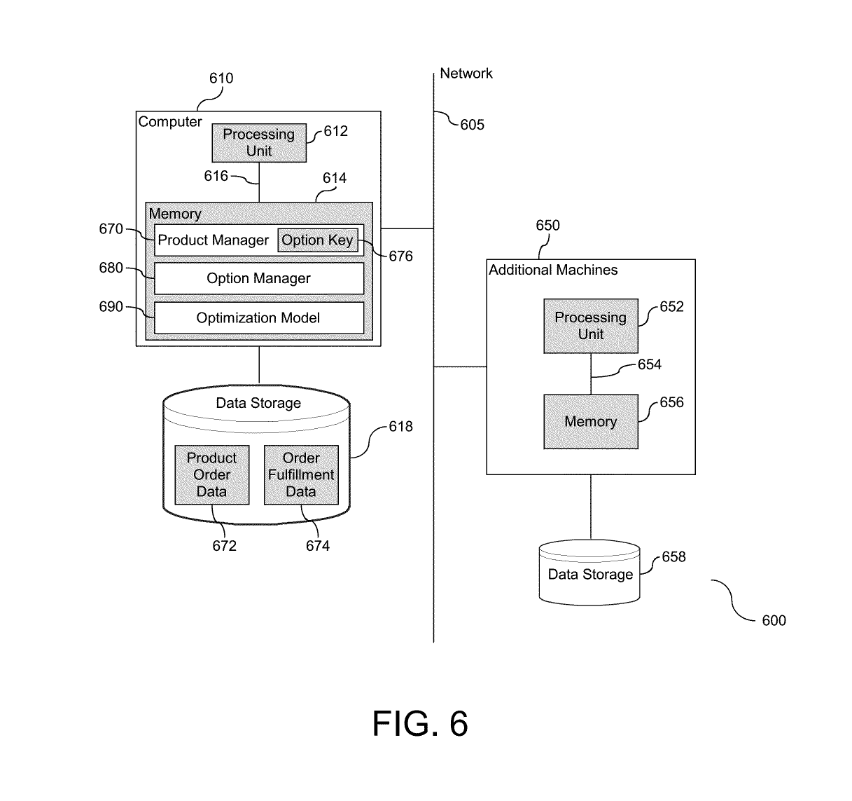

Referring to FIG. 6, a block diagram (600) is provided depicting a system for order offload. The system is shown with a computer (610) provided with a processing unit (612) in communication with memory (614) across a bus (616), and in communication with data storage (618). The computer (610) is in communication with one or more additional machines (650) across a network connection (605). Each of the additional machines (650) is provided with a processing unit (652) in communication with memory (656) across a bus (654), and in communication with data storage (658).

Data, such as product manufacture data, product component data, and product shipping data may be stored in data storage (618). In addition, manufacturing data may also be stored in data storage (618), the manufacturing data representing machinery to support manufacture of product components, capacity of the machines, etc. A machine is configured and calibrated to manufacture one or more product components. As discussed above, one or more components or products may be offloaded to a second manufacturing site for various reasons as ascertained by the optimization model. There are many factors that encompass the decision to offload, including but not limited to, transportation time, transportation cost, time for obtaining an order component, risk consideration associated with shipping any order components, etc. In addition, such offloading may require the machinery to be calibrated in order to assemble the product and/or product component. More specifically, in one embodiment, the machinery includes a custom hardware or software component, e.g. non-generic hardware or software, modified to accept and accommodate the offload.

A product manager (670) and an option manager (680) are provided in the system as tools to support and enable collaboration of order fulfillment through inventory and resource sharing in a distributed production system. The product manager (670), which is in communication with the processing unit (612), functions to transform received product order data (672) into formatted order fulfillment data (674). More specifically, the product manager (670) inserts an option key (676) into the optimization model (690). The option key (676) creates formatted data in the form of one or more product manufacture objective(s), which in one embodiment is formatted for receipt by the optimization model (690). In one embodiment, the objectives include one or more of the following: order type, order ship data, required parts, and customer requirements. Output, in the form of formatted order fulfillment data (674), is generated from the model (690). In one embodiment, the fulfillment represents a product manufacturing objective, while accounting for available time to obtain a product component. The option manager (680) returns the formatted data (674) from the model (690), with the returned data identifying an optimal shipping option that meets the objective. In addition, the option manager (680) applies the formatted data (674) to allocate a workload for the product. Each machine used in manufacturing of products is calibrated to produce the products to specification, and also has capacity limits in that there is a finite set of products that can be produced by the machinery in a set period of time. The option manager (680) functions to offload manufacture to a machine that can meet the capacity requirements for assembly, and also ensure that the machine can be and is calibrated to receive and process component manufacturing in a manner that reduces the cost of order fulfillment.

The optimization model (690) functions to identify product allocation workload in the distributed production system. More specifically, the optimization model (690) identifies capacity constraints, including physical facilities, component and product shipping date, availability of an order component, and shipping costs. Each of these identified constraints may affect the decision by the model (690) to offload to a secondary site, which also includes configuration of one or more special hardware components to accommodate any change in production based on the allocation or re-allocation.

Manufacture of products and associated components has an associated supply risk and a demand risk. As noted above, the option manager (680) selects an optimal shipping option. The optimal aspect in the selection is based on reducing both the supply risk and the demand risk. For example, the assessed risk may pertain to a specific hardware component used in manufacture. To reduce the assessed burden and risk, parts required for the manufacture may be trans-shipped between different supply chain locations.

The computer described above in FIG. 6 has been labeled with a product manager (670) and an option manager (680), to facilitate corroborative order fulfillment through inventory and resource sharing in a distributed production system. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

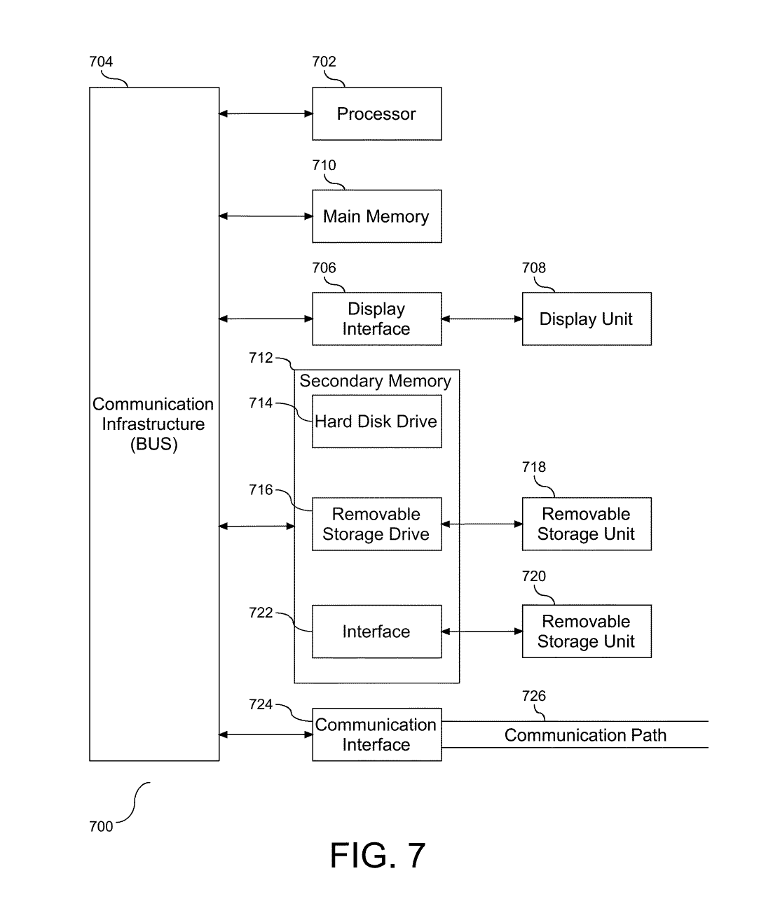

Referring now to the block diagram of FIG. 7, additional details are now described with respect to implementing an embodiment of the present invention. The computer system includes one or more processors, such as a processor (702). The processor (702) is connected to a communication infrastructure (704) (e.g., a communications bus, cross-over bar, or network).

The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712). The secondary memory (712) may include, for example, a hard disk drive (714) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by removable storage drive (716).

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) is in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions/acts specified in the flowcharts and/or block diagrams block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowcharts and/or block diagrams block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The implementation of the order offload is demonstrative of collaborative order fulfillment through inventory and resource sharing in a distributed production system. Accordingly, output from the optimization model represents the optimal allocation of orders to plants and the trans-shipment of parts between the plants, including calibration of any tools for product component manufacturing to accommodate the order offload.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

What is claimed is:

1. A method for collaborative order fulfillment through inventory and resource sharing in a distributed production system, comprising:
transforming, at a host computer, received product order data by inserting an option key into an optimization model, the option key formatting one or more product manufacture objectives, and the optimization model to create formatted order fulfillment data;
returning, from the host computer, the formatted order fulfillment data to identify an optimal shipping option to meet the objective; and
applying the formatted order fulfillment data to a product allocation workload, including calibration of a product component manufacturing tool to minimize cost of order fulfillment by offloading at least one component of the product order to a supply chain location having the calibrated tool.

2. The method of claim 1, further comprising identifying available raw material associated with the received product order in a nested supply chain, and determining inter-plant shipment options for the identified raw material.

3. The method of claim 2, further comprising the optimization model identifying the product allocation workload, including identifying a capacity constraint selected from the group consisting of: one or more physical facilities, a shipping date, availability of an order component, and a shipping cost.

4. The method of claim 3, further comprising selecting the optimal shipping option to mitigate a supply risk and a demand risk in a nested fabrication-fulfillment environment by trans-shipping parts between different supply chain locations.

5. The method of claim 1, wherein the optimization model calculates available time for obtaining at least one product component.

6. The method of claim 1, further comprising the optimization model identifying a transportation factor selected from the group consisting of: transportation time, transportation cost, time for obtaining an order component, a risk consideration for shipping the order component, and combinations thereof.

7. A computer program product for collaborative order fulfillment through inventory and resource sharing in a distributed production system, the computer program product comprising a computer readable storage device having program code embodied therewith, the program code executable by a processing unit to:
transform, at a host computer, received product order data by inserting an option key into an optimization model, the option key to format one or more product manufacturing objective, and the optimization model to create formatted order fulfillment data;
return, from the host computer, the formatted order fulfillment data to identify an optimal shipping option to meet the objective; and
apply the formatted order fulfillment data to a product allocation workload, including calibration of a product component manufacturing tool to minimize cost of order fulfillment by offloading at least one component of the product order to a supply chain location having the calibrated tool.

8. The computer program of claim 7, further comprising program code to identify available raw material associated with the received product order in a nested supply chain, and to determine inter-plant shipment options for the identified raw material.

9. The computer program product of claim 8, further comprising program code to identify the product allocation workload, including identifying a capacity constraint selected from the group consisting of: one or more physical facilities, a shipping date, availability of an order component, and a shipping cost.

10. The computer program product of claim 9, further comprising program code to select the optimal shipping option to mitigate a supply risk and a demand risk in a nested fabrication-fulfillment environment by trans-shipping parts between different supply chain locations.

11. The computer program product of claim 7, wherein the optimization model calculates available time for obtaining at least one product component.

12. The computer program product of claim 7, further comprising the optimization model to identify a transportation factor selected from the group consisting of: transportation time, transportation cost, time for obtaining an order component, a risk consideration for shipping the order component, and combinations thereof.

13. A system comprising:
a processing unit in communication with memory;
a product manager in communication with the processing unit, the product manager to transform received product order data by insertion of an option key into an optimization model, the option key to format one or more product manufacture objectives, and the optimization model to create formatted order fulfillment data;
an option manager in communication with the processing unit, the option manager to return the formatted order fulfillment data to identify an optimal shipping option to meet the objective; and
the option manager to apply the formatted order fulfillment data to a product allocation workload, including calibration of a product component manufacturing tool to minimize cost of order fulfillment by offloading at least one component of the product order to a supply chain location having the calibrated tool.

14. The system of claim 13, further comprising the optimization model to identify available raw material associated with the received product order in a nested supply chain, and to determine inter-plant shipment options for the identified raw material.

15. The system of claim 14, further comprising the optimization model to identify the product allocation workload, including identifying a capacity constraint selected from the group consisting of: one or more physical facilities, a shipping date, availability of an order component, and a shipping cost.

16. The system of claim 15, further comprising the option manager to select the optimal shipping option to mitigate a supply risk and a demand risk in a nested fabrication-fulfillment environment, including trans-shipping parts between different supply chain locations to mitigate burden on select hardware.

17. The system of claim 13, wherein the optimization model calculates available time for obtaining at least one product component.

18. The system of claim 13, further comprising the optimization model to identify a transportation factor selected from the group consisting of: transportation time, transportation cost, time for obtaining an order component, a risk consideration for shipping the order component, and combinations thereof.
